(19) United States
(12) Patent Application Publication
(10) Pub. No.: US 2024/0055758 A1
(43) Pub. Date: Feb. 15, 2024

(54) HIGH SINR SYNCHRONIZED-BEAMS MOBILE NETWORK AND BASE-STATION ANTENNA DESIGN

(71) Applicant: Matsing, Inc., Irvine, CA (US)

(72) Inventors: Serguei Matitsine, Dallas, TX (US); Leonid Matytsine, Irvine, CA (US); John Stewart Wilson, Huntington Beach, CA (US)

(21) Appl. No.: 18/233,111

(22) Filed: Aug. 11, 2023

Related U.S. Application Data
(60) Provisional application No. 63/397,113, filed on Aug. 11, 2022.

(51) Int. Cl. H01Q 3/24; H01Q 15/02; H04B 7/0426

(52) U.S. Cl. CPC H01Q 3/24; H01Q 15/02; H04B 7/043

(57) ABSTRACT

A multi-beam communication system uses an array of antenna assemblies, and RF elements, to provide two or more sets of multiple beams, where each individual set of beams can be considered a beam state. An antenna assembly has a first set of RF elements oriented to produce a first beam state, and a second set of RF elements oriented to produce a second beam state. Each set of RF elements comprise a set of output sectors, where a controller is configured to selectively activate a beam state.

This application claims priority to the following case: U.S. provisional application Ser. No. 63/397,113 filed Aug. 11, 2022, entitled “High SINR Synchronized-Beams Mobile Network and Base-Station Antenna Design”. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is RF frequency antenna and lenses.

### BACKGROUND

The background description includes information that may be useful in understanding the present invention. It is not an admission that any of the information provided herein is prior art or relevant to the presently claimed invention, or that any publication specifically or implicitly referenced is prior art.

With the introduction of 5G and Third Generation Partnership Project (3GPP) Releases 16, and the coming Releases 17 and 18, when possible, beam selection plays an important role in achieving goals for key network performance metrics such as data throughput, QOS, and capacity. The 3GPP standards include Inter-cell Interference Coordination (ICIC) introduced in Release 8 that mitigates interference by restricting part of the frequency spectrum for UEs at the cell edge, and Release 9 introduced enhanced Inter-cell Interference Coordination (eICIC) where the concept of almost blank sub-frames (ABS) is introduced for further interference mitigation, Release 10 further added further enhanced Inter-cell Interference Coordination (FeICIC) with advanced channel state information (CSI) functions as well as Coordinated Multi-point (CoMP) that further mitigates inter-cell interference through sharing of the eNB. So while the 3GPP standards have focused considerable effort on intercell interference over the past 15 years an RF lens techniques of beam selection still has merit and the switching that is graphically described here can be implemented within the standard as the switching can serve as an analog to blanking subframes as one example.

The user equipment (UE) requires increased signal to noise and interference ratio (SINR) to achieve higher performance 256 QAM (quadrature amplitude modulation). However as the number of UE's has increased over time, as has the demand for higher thru-put and capacity, more beams/sectors/radios have been deployed throughout the network to keep up with this increased demand. As more beams/sectors/radios are introduced in the network, the interference between these beams/sectors/radios is increased, in other words as more sectors are introduced to keep up with capacity demands, more SINR is inherently created as there are more beams interfering with each other. Therefore a key drawback of earlier techniques was the poor SINR with “always on” multiple beams, particularly in areas where beams cross over creating increased SINR and reducing CQI, and lack of standardization for beam selection.

A more recent approach to reduce SINR within a single sector has been the introduction of MIMO/beam forming antenna technology. Instead of using a traditional approach of a static beam (or multiple static beams for increased capacity), this technology uses a single non-static sector at a time, moving and shaping a single active beam to provide coverage to different geographical locations within the sector. By using a single non-static beam, SINR is reduced as there is now only a single sector/beam operating at a time. However there can still be significant interference or SINR created from the adjacent sector or cell site and thus a solution on how to achieve high SINR between two separate sectors is still needed. Furthermore this approach is limited to having a single radio cover a geographical area and does not provide a good SINR isolation when multiple beams are needed for a single sector.

Therefore a new approach is suggested for optimizing network performance.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

A solution that is best implemented using RF lens antenna with assemblies providing two or more sets of multiple beams. Each individual set of beams can be considered as a “beam state” for purposes of network operation as a given state describes the set of patterns available to the network at that slice of time. A key performance advantage to providing two or more beam states is that a given beam state has very high SINR over all angles within the beam to a referenced power level. As an example, beam states can be designed so that within the 3 dB or 10 dB pattern level the SINR is greater than 20 dB. This high SINR over an appreciable part of the beam is possible since the nearest adjacent beam is only producing side lobes at a low level. In 3 GPP terminology a state can be considered a radio frame or subframe and when the term “switching” is used herein can be considered as an ABS, or equivalent, as defined in the standards, changing from one wireless channel to another wireless channel.

As required by the network, two or more sets of output beams can be alternatively selected to achieve high SINR coverage over the entire sector. This arrangement has a further advantage as it allows for one or more radios per sector up to a single radio per beam set, thereby increasing capacity without increasing the physical footprint of additional cell sites. The same idea can be extended over the entire three sectors of a typical cell site and over a cluster of numerous cell sites insuring high SINR over a significant portion of the network.

Various objects, features, aspects, and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWINGS

FIG. 1A illustrates an exemplary antenna system.

FIG. 1B illustrates an exemplary antenna system in a first beam state.

FIG. 1C illustrates an exemplary antenna system in a second beam state.

FIG. 1D illustrates an exemplary antenna system with two beam states, each with a set of output beams.

FIG. 1E illustrates an exemplary antenna system with three beam states, each with a set of output beams.

FIG. 2 is a schematic of an exemplary antenna system with an RF lens and controllers, where each controller includes two associated RF elements.

FIG. 3 illustrates an alternative antenna system with three controllers, each with multiple RF elements.

FIG. 4 illustrates a similar antenna system to FIG. 1D, but for a complete three sector site.

FIG. 5 illustrates an alternative antenna system with multiple output sites, each having multiple output beams and configured for multiple beam states.

### DETAILED DESCRIPTION

As used in the description herein and throughout the claims that follow, when a system, engine, or a module is described as configured to perform a set of functions, the meaning of “configured to” or “programmed to” is defined as one or more processors being programmed by a set of software instructions to perform the set of functions.

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

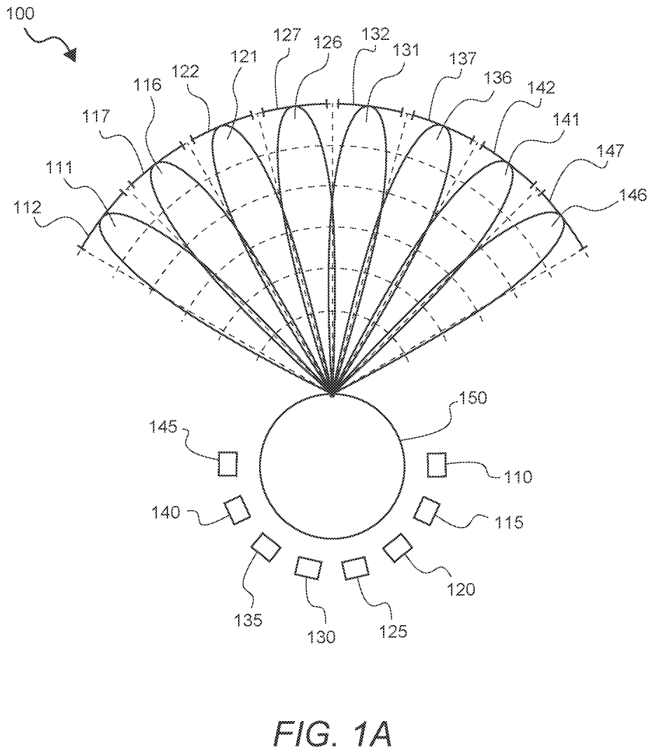

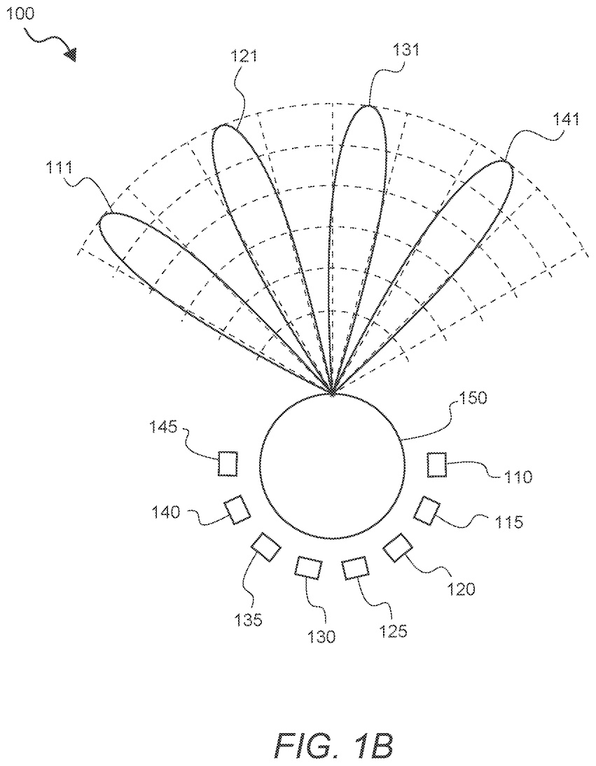

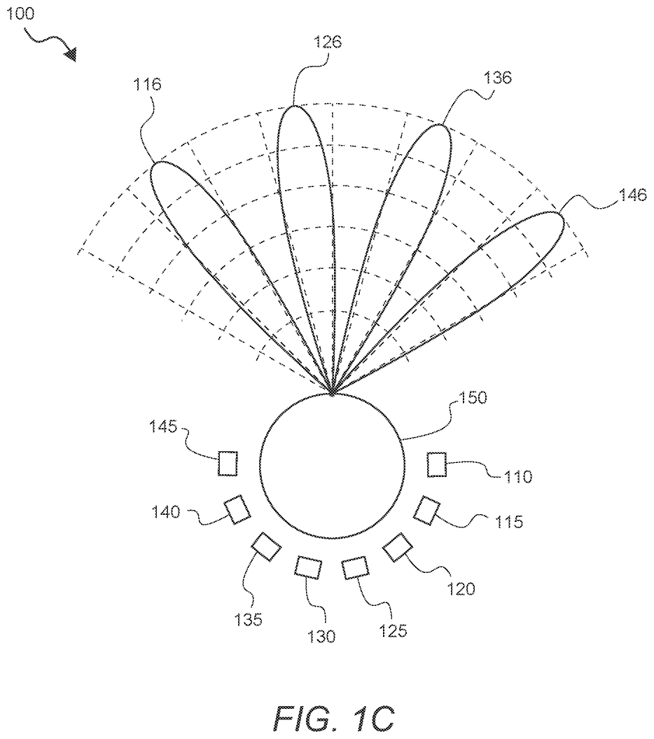

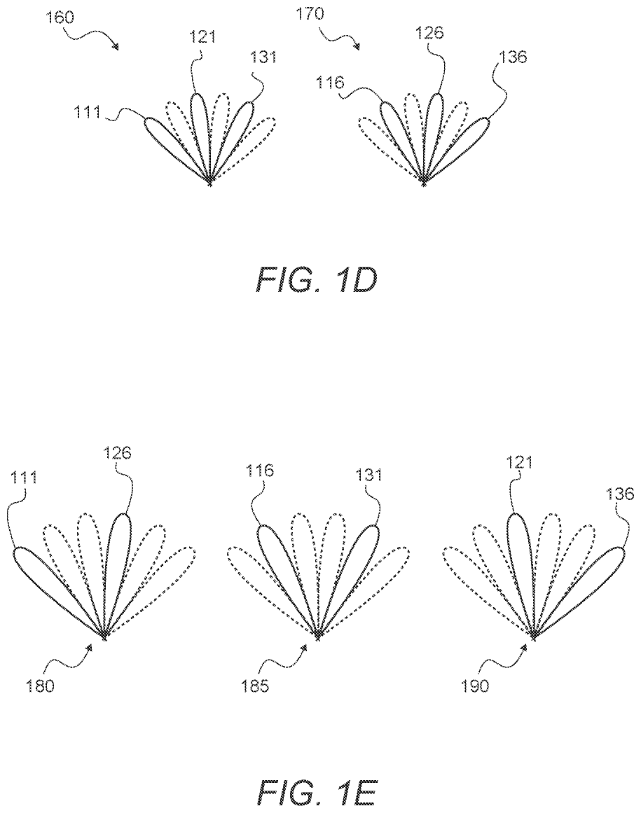

FIG. 1 illustrates an antenna system 100 according to some embodiments of the inventive subject matter. In the depicted embodiment, the antenna system 100 includes a spherical lens 150. A spherical lens is a lens with a surface having a shape of (or substantially having a shape of) a sphere. As defined herein, a lens with a surface that substantially conform to the shape of a sphere means at least 50% (preferably at least 80%, and even more preferably at least 90%) of the surface area conforms to the shape of a sphere. Examples of spherical lenses include a spherical-shell lens, the Luneburg lens, etc. The spherical lens can include only one layer of dielectric material, or multiple layers of dielectric material. A conventional Luneburg lens is a spherically symmetric lens that has multiple layers inside the sphere with varying indices of refraction.

The antenna system 100 also includes multiple RF element assemblies associated with the spherical lens 150. An RF element assembly can include an emitter, a receiver, or a transceiver. As shown, the antenna system 100 includes RF element assemblies 110, 115, 120, 125, 130, 135, 140, and 145. In this example, each of the element assemblies only includes one RF element, but it has been contemplated that each element assembly can house multiple RF elements.

In FIG. 1A, RF element assembly 110 produces output beam 111, RF element assembly 120 produces output beam 121, RF element assembly 130 produces output beam 131, RF element assembly 140 produces output beam 141, RF element assembly 115 produces output beam 116, RF element assembly 125 produces output beam 126, RF element assembly 135 produces output beam 136, and RF element assembly 145 produces output beam 146. Each RF element assembly generates an output beam, which can be adjusted by its associated sub-controller (not shown), to provide coverage to an output sector. The antenna system 100 includes output sectors 112, 117, 122, 127, 132, 137, 142, and 147. In a preferred embodiment, the output beams 111, 116, 121, 126, 131, 136, 141, and 146 for the spherical lens 150 are produced by the eight RF elements of antenna system 100 separated at 15 degree spacings, to produce eight sectors, and centered at −52.5, −37.5, −22.5, −7.5, 7.5, 22.5, 37.5, and 52.5 degrees. In some embodiments, the spherical lens 150 is a 180 cm diameter spherical Lundberg lens.

In exemplary embodiments, each RF element (from RF element assemblies 110, 115, 120, 125, 130, 135, 140 and 145) is configured to transmit an output beam (e.g., a radio frequency signal) in the form of a beam to the atmosphere through its corresponding spherical lens. The spherical lens 150 allows the output RF signal to narrow so that the resultant beam can travel a farther distance. In some embodiments, at least some RF elements are configured to receive/detect incoming signals that have been focused by the spherical lens 150.

In some embodiments, the output beams for a 180 cm diameter spherical Lundberg lens (not shown) with eight RF elements are separated at 15 degree spacings centered at −52.5, −37.5, −22.5, −7.5, 7.5, 22.5, 37.5, and 52.5 degrees. This beam separation pattern can represent the case where a multi-beam system simultaneously uses eight beams to cover a traditional 120-degree sector in a cellular network to improve throughput, Quality of Signal (QOS), and capacity.

Two characteristics of producing all beams at once are 1) the high cross-over, 2) and high side lobe level. Traditionally, cellular networks were based on 120 degree sectors where the cross-over point in the radiation patterns between sectors was designed to occur at about the 10 dB level; the inventive concept presented here in configured to be tailored for any beam cross-over level. Another consequence of the traditional antenna architecture is higher SINR levels in the area of cross over. FIG. 1A follows the traditional approach of 10 dB cross-over levels and the resulting high SINR in the cross-over region.

FIG. 1B depicts antenna system 100 in a first beam state where RF element 110 produces output beam 111, RF element 120 produces output beam 121, RF element 130 produces output beam 131, and RF element 140 produces output beam 141. Similarly, FIG. 1C depicts antenna system 100 in a second beam state where RF element 115 produces output beam 116, RF element 125 produces output beam 126, RF element 135 produces output beam 136, and RF element 145 produces output beam 146. In a preferred embodiment, the first beam state and second beam state are configured for different times. In the depicted examples, the output beams 111, 116, 121, 126, 136, 141, and 146 are sufficiently separated in azimuth angle to eliminate any meaningful cross-over level and eliminate SLL within each beam. A possible consideration related to this approach is that the eight beams require two separate time slots. Prior to the implementation of beam selection in the 3GPP standards this approach would require an “ad-hoc” mechanism to address the beam selection, but with today's standards beam selection methods are well established, and the method described here is consistent with the cell to cell interference approaches presented in the standards.

FIG. 1D depicts a similar embodiment to FIG. 1C, defining two beam states 160 and 170, where each beam state includes a set of output beams. Beam state 160 is configured to include output beams 111, 121, and 131. Beam state 170 is configured to include output beams 116, 126, and 136. The inventive subject matter is not limited to two beam states. Indeed, three or more beam states are possible depending on the embodiment. The case of three beam states is exemplified in FIG. 1E, having beam states 180, 185, and 190. Beam state 180 is configured to include output beams 111 and 126. Beam state 165 is configured to include output beams 116 and 131. Beam state 190 is configured to include output beams 121 and 136.

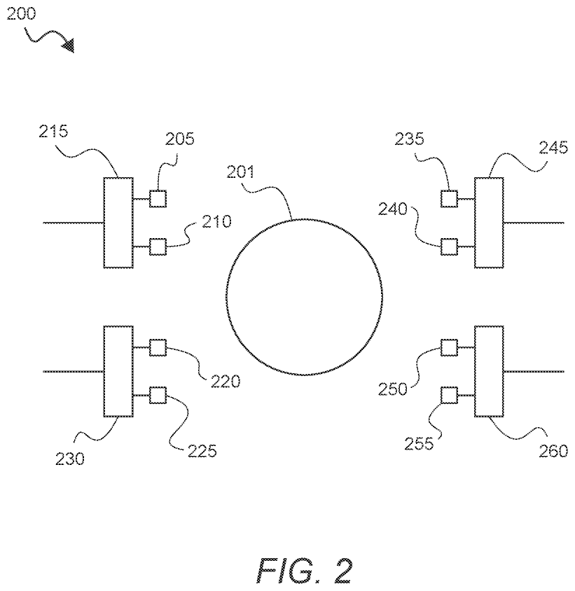

FIG. 2 illustrates another embodiment of the inventive concept with an antenna system 200 having an RF lens 201 and controllers 215, 230, 245, and 260. Each controller includes at least two associated RF elements. Controller 215 includes RF elements 205 and 210. Controller 230 includes RF elements 220 and 225. Controller 245 includes RF elements 235 and 240. Controller 260 includes RF elements 250 and 255. In some embodiments, the RF elements 205, 220, 235, and 250 are configured to output their respective output beams in a first beam state. In a related embodiment, RF elements 210, 225, 240, and 255 are configured to output their respective output beams in a second beam state. In a preferred embodiment, the controllers of antenna system 200 are configured to select between at least two beam states to produce the associated output beams. In a related embodiment, the controller 215 can be either a device in addition to the radio, or, in the more likely scenario for 5G, the controller 215 is implemented in software such that the radio equipment effectively selects between different beams for a given instant in time.

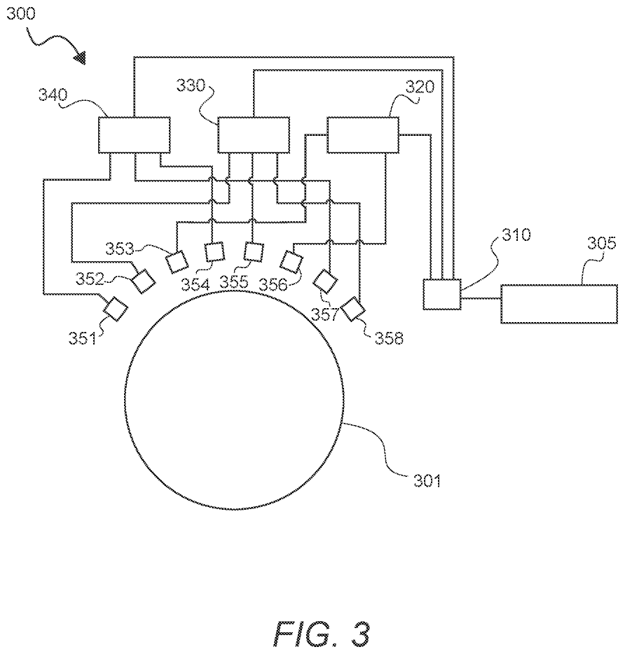

FIG. 3 illustrates one embodiment of the inventive subject matter for three beam states where a multi-beam communication system 300 includes an RF lens 301, with RF elements 351-358 arranged about RF lens 301 to produce output beams, controllers 320-340, and radio 310. In the depicted embodiment, RF elements 351, 354, and 357 are controlled via controller 340, RF elements 352, 355, and 358 are controlled via controller 330, and RF elements 353 and 356 are controlled via controller 320. Radio 310 is configured to provide commands to controllers 320-340. In some embodiments, radio 310 is a 5G new radio (e.g. gnodeB). In other embodiments, the radio 310 is a base station transceiver (BTS).

Advantageously, as depicted in FIG. 3, this configuration of an RF lens with multiple paired feed elements facilities the ability to create multiple simultaneous and independent beams for required coverage from a single antenna. This compares with flat panel arrays in an 8×8 configuration that require additional hardware and/or software to achieve similar, but degraded results due to the inability to produce consistent performance beams in an 8×8 scenario or for full 120 degree coverage from a single antenna.

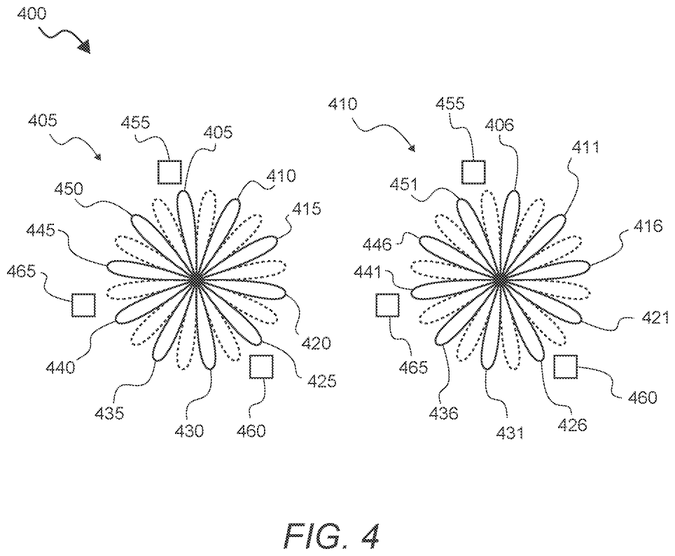

FIG. 4 depicts a similar embodiment to FIG. 1D, but for a complete three sector site. FIG. 4 depicts antenna system 400, with output beams 405, 406, 410, 411, 415, 416, 420, 421, 425, 426, 430, 431, 435, 436, 440, 441, 445, 446, 450, and 451, in a first beam state 405 and a second beam state 410. In the depicted embodiment, the antenna system 400 in first beam state 405 produces output beams 405, 410, 415, 420, 425, 430, 435, 440, 445, and 450. The antenna system 400 in the second beam state 410 produces output beams 406, 411, 416, 421, 426, 431, 436, 441, 446, and 451. In a preferred embodiment, the first beam state 405 and the second beam state 410 are asynchronous. In a related embodiment, the first beam state 405 and the second beam state 410 are at least partially synchronous.

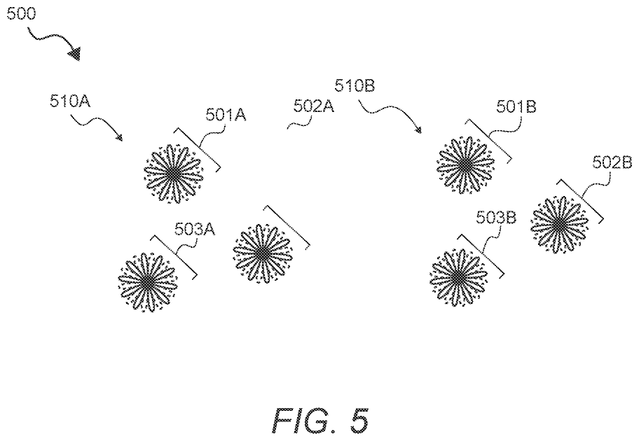

FIG. 5 illustrates the inventive concept applied to a cluster of sites. FIG. 5 depicts antenna system 500 in a first configuration 510A and a second configuration 510B, with output sites 501-503. The output site 501 produces output beams in a first beam state 501A, and a second beam state 501B. The output site 502 produces output beams in a first beam state 502A, and a second beam state 502B. The output site 503 produces output beams in a first beam state 503A, and a second beam state 503B. In the first configuration 510A, the output sites 501-503 of antenna system 500 produce output beams in first beam states 501A-503A. In the second configuration 510B, the output sites 501-503 of antenna system 500 produce output beams in first beam states 501B-503B.

In a preferred embodiment, the inventive subject matter further includes modifying the pre-coding weights that a controller or base station transceiver selects after receiving and processing the channel state information (CSI) from the mobile to allow for two or more sets of beam states derived from a beam state selection timing algorithm. In a preferred embodiment, the algorithm is configured such that only one beam state is active at a given time. In a related embodiment, the controller or base station transceiver is configured to connect one radio port to one antenna beam port, with the controller being accomplished in software and conforming to the 5G 3GPP standards.

It should be apparent to anyone skilled in the art that the novel concept of using two sets of beams emanating from an RF lens to provide significant improvement to system SINR can be applied to a wide range of embodiments where the number of beams, use of lens arrays to form beams of narrow elevation pattern, frequency ranges, number of beam outputs connected to each radio, etc. all fall under the scope of the described invention.

Furthermore, this approach of time synchronizing different beams can be applied to: 1) single sectors (synchronization of multiple beams within a single sector), 2) multiple sectors (synchronization between two or more single/or multiple beam sectors, and 3) a network (synchronization between different cell sites). Indeed, in a preferred embodiment the system can be used for beam forming for standard antennas, and antenna groups. In related embodiments, the antenna includes a lens. However, the approach does not limit itself to be used with RF Lens Antennas, although they provide a distinct advantage for this method when multiple beams are needed within an output sector or when multiple radios are needed within an output sector, but can be applied to any type of antennas.

The discussion herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of components, properties such as orientation, location, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A multi-beam communication system, comprising:
a first antenna assembly within an array of antenna assemblies;
the first antenna assembly has a first set of RF elements oriented to produce a first beam state, and a second set of RF elements oriented to produce a second beam state;
wherein the first set of RF elements comprise a first set of output sectors, and the second set of RF elements comprise a second set of output sectors; and
wherein a controller is configured to selectively activate the first beam state and the second beam state.

2. The multi-beam communication system of claim 1, wherein the first beam state further comprises a first beam set, and wherein the second beam state comprises a second beam set.

3. The multi-beam communication system of claim 1, wherein the first set of output sectors at least partially overlaps the second set of output sectors.

4. The multi-beam communication system of claim 3, wherein the first set of output sectors does not overlap the second set of output sectors.

5. The multi-beam communication system of claim 1, wherein the selective activation of the controller is function of a wireless network protocol.

6. The multi-beam communication system of claim 1, wherein the first antenna assembly further comprises a first RF lens.

7. The multi-beam communication system of claim 6, further comprising a second RF lens having a third set of RF elements oriented to produce a third set of output sectors, and a fourth set of RF elements oriented to produce a fourth set of output sectors.

8. The multi-beam communication system of claim 6, wherein at least some of the beam states operate simultaneously, within 0.5 to 30 GHz.

9. The multi-beam communication system of claim 1, wherein the controller is further configured to selectively activate the first beam state independently from the second beam state.

10. The multi-beam communication system of claim 1, wherein the controller is further configured to combine at least the first beam state and the second beam state into a combined beam state, and wherein the combined beam state is configured for 120 degrees of coverage.

12. The multi-beam communication system of claim 1, wherein the controller is further configured to selectively activate the first beam state and the second beam state as a function of time

13. The multi-beam communication system of claim 6, wherein the first RF lens is configured such that selective activation of the first beam state alters the first output beam with respect to at least one of a beam frequency range, beamwidth, a beam-direction, a beam polarization, a beam gain, and a beam sidelobe level.

14. The multi-beam communication system of claim 1, further comprising a second antenna assembly within the array of antenna assemblies;
the second antenna assembly has a third set of RF elements oriented to produce a third beam state, and a fourth set of RF elements oriented to produce a fourth beam state;
wherein the third set of RF elements comprise a third set of output sectors, and the fourth set of RF elements comprise a fourth set of output sectors; and
wherein the controller is configured to selectively activate the third beam state and the fourth beam state.

15. The multi-beam communication system of claim 14, wherein the third beam state further comprises a third beam set, and wherein the third beam state comprises a third beam set.

16. The multi-beam communication system of claim 14, wherein the third beam state is the same as the first beam state.

17. The multi-beam communication system of claim 14, wherein the third beam state is different from the first beam state.
